(19) United States
(12) Patent Application Publication
(10) Pub. No.: US 2019/0131087 A1
(43) Pub. Date: May 2, 2019

(54) KEYBOARD DEVICE

(71) Applicant: Primax Electronics Ltd., Taipei City (TW)

(72) Inventors: Bo-An Chen, Taipei City (TW); Chin-Sung Pan, Taipei City (TW)

(21) Appl. No.: 15/878,973

(22) Filed: Jan. 24, 2018

(30) Foreign Application Priority Data
Oct. 27, 2017 (TW) 106137176

(51) Int. Cl. H01H 13/705; G06F 3/02

(52) U.S. Cl. CPC H01H 13/705; G06F 3/0202

(57) ABSTRACT

A keyboard device includes a base plate, a key structure and a membrane switch circuit member. The membrane switch circuit member includes a first board and a second board. The first board includes a first circuit pattern, a conductive paste mark and a first insulation layer. The conductive paste mark is dispensed or sprayed on the first board or the first circuit pattern to define an equivalent resistance. Consequently, a ghosting problem is avoided. The second board includes a second circuit pattern and a second insulation layer. Since the first contact and the second contact are separated from each other through the first insulation layer and the second insulation layer, it is not necessary to install the separation layer in the membrane switch circuit member.

### FIELD OF THE INVENTION

The present invention relates to a keyboard device, and more particularly to a keyboard device with a membrane switch circuit member.

### BACKGROUND OF THE INVENTION

Generally, the widely-used peripheral input device of a computer system includes for example a mouse device, a keyboard device, a trackball device, or the like. Via the keyboard device, characters or symbols can be directly inputted into the computer system. As a consequence, most users and most manufacturers of input devices pay much attention to the development of keyboard devices.

Hereinafter, a key structure with a scissors-type connecting element in a conventional keyboard will be illustrated with reference to FIG. 1. FIG. 1 is a schematic side cross-sectional view illustrating a conventional key structure. As shown in FIG. 1, the conventional key structure 1 comprises a keycap 11, a scissors-type connecting element 12, a rubbery elastomer 13, a membrane switch circuit member 14 and a base plate 15. The keycap 11, the scissors-type connecting element 12, the rubbery elastomer 13 and the membrane switch circuit member 14 are supported by the base plate 15. The scissors-type connecting element 12 is used for connecting the base plate 15 and the keycap 11.

The scissors-type connecting element 12 is arranged between the base plate 15 and the keycap 11, and the base plate 15 and the keycap 11 are connected with each other through the scissors-type connecting element 12. The scissors-type connecting element 12 comprises a first frame 121 and a second frame 122. A first end of the first frame 121 is connected with the keycap 11. A second end of the first frame 121 is connected with the base plate 15. The rubbery elastomer 13 is enclosed by the scissors-type connecting element 12. The membrane switch circuit member 14 comprises plural key intersections (not shown). When one of the plural key intersections is triggered, a corresponding key signal is generated. The rubbery elastomer 13 is disposed on the membrane switch circuit member 14. Each rubbery elastomer 13 is aligned with a corresponding key intersection. When the rubbery elastomer 13 is depressed, the rubbery elastomer 13 is subjected to deformation to push the corresponding key intersection of the membrane switch circuit member 14. Consequently, the corresponding key signal is generated.

The operations of the conventional key structure 1 in response to the depressing action of the user will be illustrated as follows. Please refer to FIG. 1 again. When the keycap 11 is depressed, the keycap 11 is moved downwardly to push the scissors-type connecting element 12 in response to the depressing force. As the keycap 11 is moved downwardly relative to the base plate 15, the keycap 11 pushes the corresponding rubbery elastomer 13. At the same time, the rubbery elastomer 13 is subjected to deformation to push the membrane switch circuit member 14 and trigger the corresponding key intersection of the membrane switch circuit member 14. Consequently, the membrane switch circuit member 14 generates a corresponding key signal. When the keycap 11 is no longer depressed by the user, no external force is applied to the keycap 11 and the rubbery elastomer 13 is no longer pushed by the keycap 11. In response to the elasticity of the rubbery elastomer 13, the rubbery elastomer 13 is restored to its original shape to provide an upward elastic restoring force. Consequently, the keycap 11 is returned to its original position where it is not depressed. The structures and the operations of the conventional keyboard device have been mentioned as above.

Conventionally, the keys of the keyboard device are arranged in a keyboard matrix. When one key is depressed, a keyboard controller realizes the information of the depressed key according to the column information and the row information and outputs the corresponding key signal. Generally, the intersection between each row and each column of the keyboard matrix represents a corresponding key intersection. When one keycap is triggered, the keyboard device starts to scan the keyboard matrix and recognizes which keycap is depressed. For example, the keyboard controller scans all columns of the keyboard matrix sequentially. If the corresponding signal is received from a specified row when a specified column is scanned by the keyboard controller, the keyboard controller can realize which key is depressed according to the received column information and row information.

The minimum matrix unit of the keyboard matrix is composed of four keys. When any of the four keys is depressed, the corresponding key signal can be successfully generated. When two of the four keys are arbitrarily depressed, the keyboard controller can realize which keys are triggered. However, when three keys are simultaneously depressed, the information of two rows and the information of two columns are transmitted to the keyboard controller. Since four keys are defined by two rows and two columns, the keyboard controller cannot recognize the three depressed keys from the four keys according to the row information and the column information only. Under this circumstance, the fourth key is erroneously judged as the on-state key. That is, the fourth key is referred as a ghost key.

For avoiding the ghosting problem, the keyboard device is further equipped with plural diodes near the corresponding key intersections. Since the current is allowed to pass through the membrane switch circuit member in one direction through the arrangement of the diodes, the erroneous judgement of the ghosting problem is avoided. However, the approach of installing diodes near the corresponding key intersection still has some drawbacks. Firstly, the diode is not cost-effective. Consequently, the cost of the keyboard device is increased. Secondly, the plural diodes on the membrane switch circuit member increase the thickness of the membrane switch circuit member. The increased thickness of the membrane switch circuit member is detrimental to slimness of the keyboard device. Thirdly, the process of welding the diodes at the positions near the corresponding key intersections is very complicated.

Therefore, there is a need of providing a keyboard device with low cost and capable of avoiding the ghosting problem

### SUMMARY OF THE INVENTION

An object of the present invention provides a keyboard device with low cost and capable of avoiding the ghosting problem.

Another object of the present invention provides a keyboard device with reduced thickness and having a function of avoiding the ghosting problem.

In accordance with an aspect of the present invention, there is provided a keyboard device. The keyboard device includes a base plate, at least one key structure and a membrane switch circuit member. The at least one key structure is exposed outside the keyboard and connected with the base plate. The membrane switch circuit member is arranged between the base plate and the at least one key structure. When the membrane switch circuit member is pressed by the at least one key structure, at least one key signal is correspondingly generated. The membrane switch circuit member includes a first board and a second board. The first board includes a first circuit pattern and a conductive paste mark. The first circuit pattern is disposed on the first board. A first contact of the first circuit pattern is formed on the first board. The conductive paste mark is disposed on the first circuit pattern and located near the first contact. The second board includes a second circuit pattern. A second contact of the second circuit pattern is formed on the second board. When the second contact and the first contact are contacted with each other, the at least one key signal is generated. The conductive paste mark is sprayed or dispensed on the first circuit pattern so as to define an equivalent resistance.

In accordance with another aspect of the present invention, there is provided a keyboard device. The keyboard device includes a base plate, at least one key structure and a membrane switch circuit member. The at least one key structure is exposed outside the keyboard and connected with the base plate. The membrane switch circuit member is arranged between the base plate and the at least one key structure. When the membrane switch circuit member is pressed by the at least one key structure, at least one key signal is correspondingly generated. The membrane switch circuit member includes a first board and a second board. The first board includes a conductive paste mark and a first circuit pattern. The conductive paste mark is disposed on the first circuit pattern. The first circuit pattern is disposed on the first board to cover the conductive paste mark. A first contact of the first circuit pattern is formed on the first board. The second board includes a second circuit pattern. A second contact of the second circuit pattern is formed on the second board. When the second contact and the first contact are contacted with each other, the at least one key signal is generated. The conductive paste mark is sprayed or dispensed on the first board so as to define an equivalent resistance.

In an embodiment, the first board further includes a first insulation layer to cover the first circuit pattern and the conductive paste mark, so that the first contact is exposed outside the first insulation layer and the first board is insulated. The second board further includes a second insulation layer to cover the second circuit board, so that the second contact is exposed outside the second insulation layer and the second board is insulated.

From the above descriptions, the membrane switch circuit member of the keyboard device of the present invention is specially designed. The conductive paste marks are dispensed or sprayed on the first board, the second board or the circuit pattern to define the equivalent resistance. The equivalent resistance is effective to avoid the ghosting problem. Since the conductive paste marks are formed by the dispensing process or the spraying process, the layout area of the conductive paste marks can be easily increased or decreased. In other words, the equivalent resistances of the conductive paste marks can be adjusted according to the required resistance. In such way, the equivalent resistances of all conductive paste marks very close. Since the difference between the equivalent resistances of different conductive paste marks are not large, the problem of the conventional printing process is avoided. Moreover, since the keyboard device of the present invention is not equipped with the costly diodes, the fabricating cost of the keyboard device is reduced. Moreover, since the first contact and the second contact are separated from each other through the first insulation layer and the second insulation layer, it is not necessary to install the separation layer in the membrane switch circuit member. That is, the three-layered structure of the conventional membrane switch circuit member is replaced by the two-layered structure (i.e., the first board and the second board) of the membrane switch circuit member of the present invention. Consequently, the thickness of the keyboard device is reduced.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic side cross-sectional view illustrating a conventional key structure;

FIG. 2 is a schematic exploded view illustrating a portion of a keyboard device according to a first embodiment of the present invention;

FIG. 3 is a schematic cross-sectional view illustrating a portion of a membrane switch circuit member of the keyboard device according to the first embodiment of the present invention;

FIG. 4 is a schematic cross-sectional view illustrating a portion of a membrane switch circuit member of a keyboard device according to a second embodiment of the present invention;

FIG. 5 is a schematic exploded view illustrating a portion of a keyboard device according to a third embodiment of the present invention; and

FIG. 6 is a schematic cross-sectional view illustrating a portion of a membrane switch circuit member of the keyboard device according to the third embodiment of the present invention.

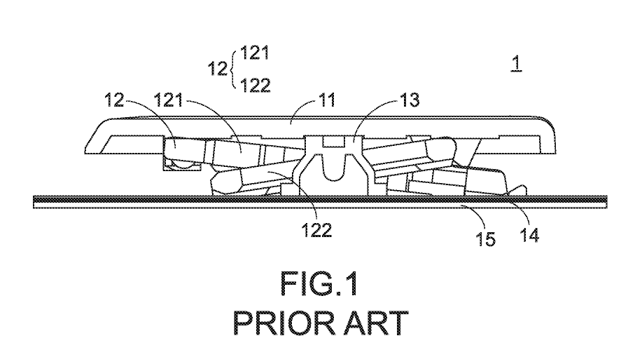

### DETAILED DESCRIPTION OF THE PREFERRED EMBODIMENT

For solving the drawbacks of the conventional technologies, the present invention provides a keyboard device.

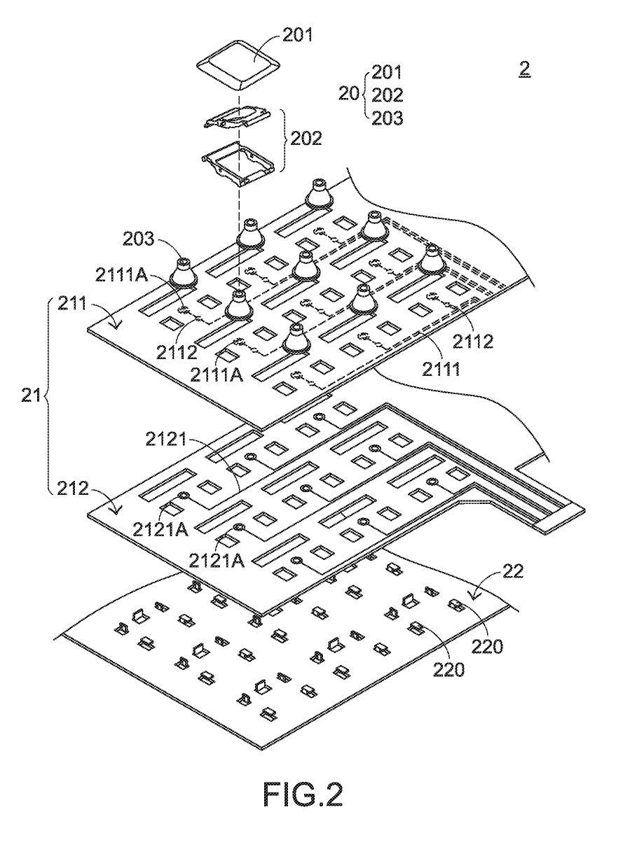

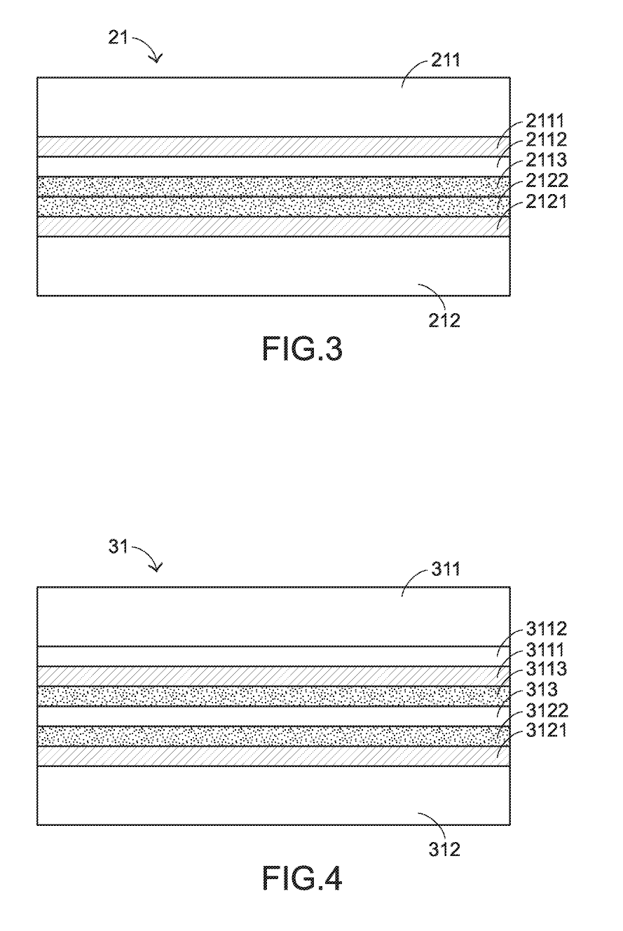

Hereinafter, the structure of the keyboard device of the present invention will be illustrated with reference to FIGS. 2 and 3. FIG. 2 is a schematic exploded view illustrating a portion of a keyboard device according to a first embodiment of the present invention. FIG. 3 is a schematic cross-sectional view illustrating a portion of a membrane switch circuit member of the keyboard device according to the first embodiment of the present invention. The keyboard device 2 comprises plural key structures 20, a membrane switch circuit member 21 and a base plate 22. The plural key structures 20 are exposed to a top surface of the keyboard device 2 and connected with the base plate 22. When one of the key structures 20 is depressed, the key structure 20 is moved downwardly relative to the base plate 22. Each key structure 20 comprises a keycap 201, a connecting element 202 and an elastic element 203. The keycap 201 is exposed outside the top surface of the keyboard device 2 so as to be depressed by the user. The connecting element 202 is arranged between the base plate 22 and the corresponding keycap 201. The connecting element 202 is used for connecting the base plate 22 and the keycap 201 and allowing the keycap 201 to be moved upwardly or downwardly relative to the base plate 22. The elastic element 203 is disposed under the corresponding keycap 201 and penetrated through the corresponding connecting element 202. The elastic element 203 is used for providing an elastic force to the keycap 201. In response to the elastic force, the keycap 201 is moved upwardly and returned to its original position.

The membrane switch circuit member 21 is arranged between the base plate 22 and the plural key structures 20. When the membrane switch circuit member 21 is pressed by one of the key structures 20, a corresponding key signal is generated. The base plate 22 is located under the membrane switch circuit member 21. The plural key structures 20 and the membrane switch circuit member 21 are supported by the base plate 22. As shown in FIG. 3, the base plate 22 comprises plural hooks 220 corresponding to the key structures 20. The hooks 220 are connected with the corresponding connecting elements 202, so that the keycaps 201 are fixed on the base plate 22.

In this embodiment, the keyboard device 2 is a keyboard device for a notebook computer. Moreover, the connecting element 202 is a scissors-type connecting element (also referred as a scissors member) that is swung with the movement of the keycap 201. Moreover, the elastic element 203 is a rubbery elastomer. The examples of the above components are presented herein for purpose of illustration and description only. In another embodiment, the crater-shaped connecting elements for a desktop computer can be used to connect and move the keycaps. In a further embodiment, the keycaps are moved upwardly or downwardly in response to magnetic forces.

Please refer to FIGS. 2 and 3 again. In this embodiment, the membrane switch circuit member 21 comprises a first board 211 and a second board 212. The first board 211 comprises a first circuit pattern 2111, plural conductive paste marks 2112 and a first insulation layer 2113. The first circuit pattern 2111 is disposed on a surface of the first board 211. Moreover, plural first contacts 2111A of the first circuit pattern 2111 are formed on the first board 211. The conductive paste marks 2112 are disposed on the first circuit pattern 2111 and located near the corresponding first contacts 2111A. In an embodiment, the conductive paste marks 2112 are disposed on the first circuit pattern 2111 by using a dispensing process. The conductive paste marks 2112 have the shapes of circular dots. Consequently, an equivalent resistance is defined by the conductive paste mark 2112. The equivalent resistance is effective to avoid the ghosting problem. The principles of using the equivalent resistance to avoid the ghosting problem are well known to those skilled in the art, and are not redundantly described herein. Moreover, the first circuit pattern 2111 and the conductive paste marks 2112 are covered by the first insulation layer 2113. The first insulation layer 2113 provides the insulating function to the first board 211. The first insulation layer 2113 is not aligned with the first contacts 2111A. Consequently, the first contacts 2111A are exposed outside the first insulation layer 2113. In an embodiment, the first circuit pattern 2111 is made of silver paste and formed on the first board 211 by a printing process. Moreover, the conductive paste marks 2112 are made of high resistance carbon paste.

The second board 212 comprises a second circuit pattern 2121 and a second insulation layer 2122. Moreover, plural second contacts 2121A of the second circuit pattern 2121 are formed on the second board 212. When one of the second contacts 2121A and the corresponding first contact 2111A are contacted with each other, the corresponding key signal is generated. The second circuit pattern 2121 is covered by the second insulation layer 2122. The second insulation layer 2122 provides the insulating function to the second board 212. The second insulation layer 2122 is not aligned with the second contacts 2121A. Consequently, the second contacts 2121A are exposed outside the second insulation layer 2122. The first insulation layer 2113 and the second insulation layer 2122 are contacted with each other. Consequently, the first contacts 2111A and the second contacts 2121A are separated from each other through the first insulation layer 2113 and the second insulation layer 2122.

In an embodiment, both of the first board 211 and the second board 212 are made of polyethylene terephthalate (PET). The second circuit pattern 2121 is made of silver paste and formed on the second board 212 by a printing process. In an embodiment, the first insulation layer 2113 is a UV-resistant layer. Moreover, the first insulation layer 2113 is printed on the first circuit pattern 2111 and the conductive paste marks 2112 to cover the first circuit pattern 2111 and the conductive paste marks 2112. Similarly, the second insulation layer 2122 is also a UV-resistant layer. The second insulation layer 2122 is printed on the second circuit pattern 2121 to cover the second circuit pattern 2121.

The structure of the membrane switch circuit member 21 is shown in FIG. 3. From top to bottom, the first board 211, the first circuit pattern 2111, the conductive paste marks 2112, the first insulation layer 2113, the second insulation layer 2122, the second circuit pattern 2121 and the second board 212 are sequentially shown. As known, the membrane switch circuit member of the conventional keyboard device is additionally equipped with a separation layer. In accordance with a feature of the keyboard device 2 of the present invention, the first contacts 2111A and the second contacts 2121A are separated from each other through the first insulation layer 2113 and the second insulation layer 2122. Consequently, it is not necessary to install the separation layer in the membrane switch circuit member. That is, the three-layered structure of the conventional membrane switch circuit member is replaced by the two-layered structure (i.e., the first board and the second board) of the membrane switch circuit member of the present invention. Consequently, the thickness of the keyboard device is reduced. Moreover, since the conductive paste marks 2112 are formed by the dispensing process, the layout area of the conductive paste marks 2112 can be easily increased or decreased. In other words, the equivalent resistance of the conductive paste marks 2112 can be adjusted according to the required resistance.

The present invention further provides a second embodiment, which is distinguished from the first embodiment. FIG. 4 is a schematic cross-sectional view illustrating a portion of a membrane switch circuit member of a keyboard device according to a second embodiment of the present invention. In this embodiment, the keyboard device 3 comprises plural key structures (not shown), a membrane switch circuit member 31 and a base plate (not shown). Except for the structure of the membrane switch circuit member 31, the structures and functions of the other components are similar to those of the keyboard device 2 of the first embodiment.

As shown in FIG. 4, the membrane switch circuit member 31 comprises a first board 311, a second board 312 and a waterproof adhesive 313. The first board 311 comprises a first circuit pattern 3111, plural conductive paste marks 3112 and a first insulation layer 3113. The first circuit pattern 3111 is formed on a surface of the first board 311. The first circuit pattern 3111 comprises plural first contacts (not shown). The first circuit pattern 3111 is disposed on the first board 311 to cover the conductive paste marks 3112. Moreover, the first circuit pattern 3111 and the conductive paste marks 3112 are covered by the first insulation layer 3113. The first insulation layer 3113 provides the insulating function to the first board 311. In an embodiment, the conductive paste marks 3112 are disposed on the first circuit pattern 3111 by using a dispensing process. Consequently, an equivalent resistance is defined by the conductive paste mark 3112. Moreover, the first circuit pattern 3111 is printed on the first board 311 so as to cover the conductive paste marks 3112.

The second board 312 comprises a second circuit pattern 3121 and a second insulation layer 3122. The structures of the second board 312, the second circuit pattern 3121 and the second insulation layer 3122 are similar to those of the first embodiment, and are not redundantly described herein.

The waterproof adhesive 313 is arranged between the first insulation layer 3113 and the second insulation layer 3122 to prevent the foreign liquid (not shown) from contacting with the first circuit pattern 3111 or the second circuit pattern 3121. In other words, the waterproof adhesive 313 provides a waterproof function. Moreover, the waterproof adhesive 313 is not aligned with the first contacts (not shown) and the second contacts (not shown). Consequently, the electric connection of the membrane switch circuit member 31 is not influenced by the waterproof adhesive 313.

The structure of the membrane switch circuit member 31 is shown in FIG. 4. From top to bottom, the first board 311, the conductive paste marks 3112, the first circuit pattern 3111, the first insulation layer 3113, the waterproof adhesive 313, the second insulation layer 3122, the second circuit pattern 3121 and the second board 312 are sequentially shown. In comparison with the first embodiment, the process of forming the first board 311 of this embodiment is distinguished. Firstly, the conductive paste marks 3112 are dispensed on the first board 311. Then, the conductive paste marks 3112 are flattened by a fixture or other tools. After the conductive paste marks 3112 are dried, the first circuit pattern 3111 is printed. In this embodiment, the membrane switch circuit member 31 further comprises the waterproof adhesive 313. Since the waterproof adhesive 313 is very thin, the slimness of the keyboard device 3 is maintained.

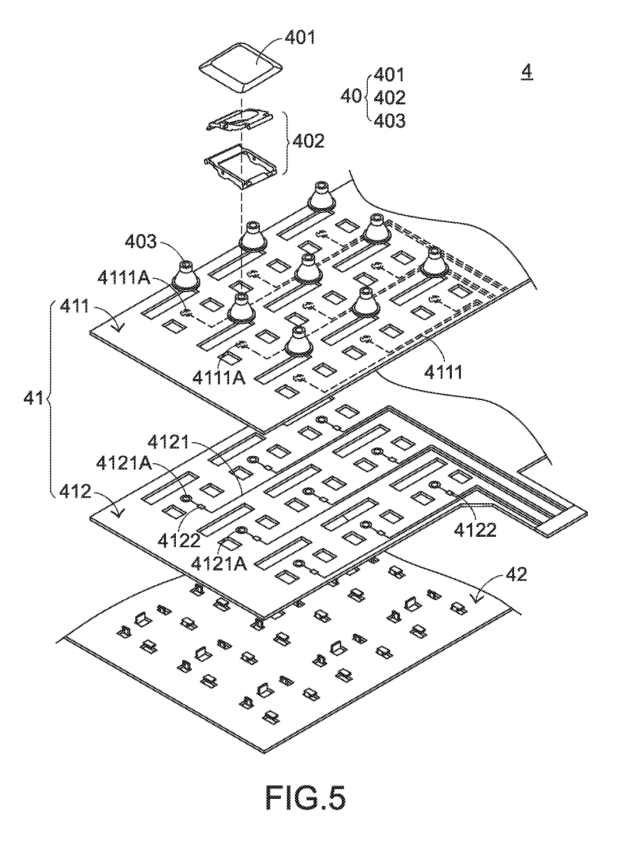

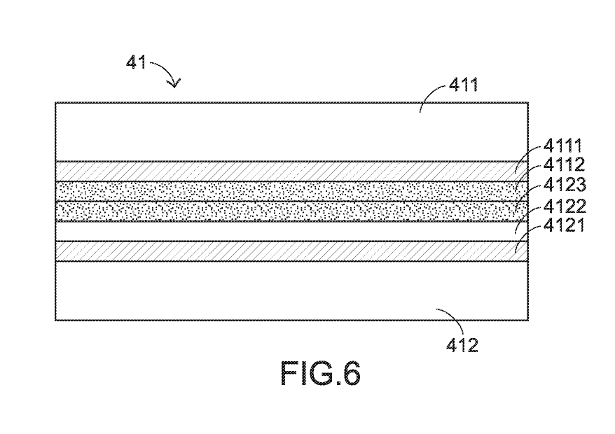

The present invention further provides a third embodiment, which is distinguished from the above embodiments. FIG. 5 is a schematic exploded view illustrating a portion of a keyboard device according to a third embodiment of the present invention. FIG. 6 is a schematic cross-sectional view illustrating a portion of a membrane switch circuit member of the keyboard device according to the third embodiment of the present invention. The keyboard device 4 comprises plural key structures 40, a membrane switch circuit member 41 and a base plate 42. Each key structure 40 comprises a keycap 401, a connecting element 402 and an elastic element 403. Except for the structure of the membrane switch circuit member 41, the structures and functions of the other components are similar to those of the keyboard device 2 of the first embodiment.

The membrane switch circuit member 41 comprises a first board 411 and a second board 412. The first board 411 comprises a first circuit pattern 4111 and a first insulation layer 4112. Moreover, plural first contacts 4111A of the first circuit pattern 4111 are formed on the first board 411. The first circuit pattern 4111 is covered by the first insulation layer 4112. The first insulation layer 4112 provides the insulating function to the first board 411. The first insulation layer 4112 is not aligned with the first contacts 4111A. Consequently, the first contacts 4111A are exposed outside the first insulation layer 4112.

The second board 412 comprises a second circuit pattern 4121, plural conductive paste marks 4122 and a second insulation layer 4123. The second circuit pattern 4121 is formed on a surface of the second board 412. Moreover, plural second contacts 4121A are formed on the second board 412. The conductive paste marks 4122 are formed on the second circuit pattern 4121 and located near the corresponding second contacts 4121A. The second circuit pattern 4121 and the conductive paste marks 4122 are covered by the second insulation layer 4123. The second insulation layer 4123 provides the insulating function to the second board 412. The second insulation layer 4123 is not aligned with the second contacts 4121A. Consequently, the second contacts 4121A are exposed outside the second insulation layer 4123. In an embodiment, the second circuit pattern 4121 is printed on the second board 412. Moreover, the conductive paste marks 4122 are sprayed on the second circuit pattern 4121. The conductive paste marks 4122 have the shapes of strips. Consequently, an equivalent resistance is defined by the conductive paste marks 4122. The equivalent resistance is effective to avoid the ghosting problem.

The structure of the membrane switch circuit member 41 is shown in FIG. 6. From top to bottom, the first board 411, the first circuit pattern 4111, the first insulation layer 4112, the second insulation layer 4123, the conductive paste marks 4122, the second circuit pattern 4121 and the second board 412 are sequentially shown. In comparison with the first embodiment, the process of forming the second board 412 of this embodiment is distinguished. Firstly, the second circuit pattern 4121 is printed on the second board 412. Then, a spray-masking jig is placed on the target positions. Then, the conductive paste marks 4122 are sprayed on the second circuit pattern 4121. It is noted that numerous modifications and alterations may be made while retaining the teachings of the invention. For example, in another embodiment, the conductive paste marks are firstly sprayed on the second board, and then the second circuit pattern is printed on the conductive paste marks to cover the conductive paste marks. Alternatively, the waterproof adhesive is installed in the membrane switch circuit member according to the practical requirements.

From the above descriptions, the membrane switch circuit member of the keyboard device of the present invention is specially designed. The conductive paste marks are dispensed or sprayed on the first board, the second board or the circuit pattern to define the equivalent resistance. The equivalent resistance is effective to avoid the ghosting problem. Since the conductive paste marks are formed by the dispensing process or the spraying process, the layout area of the conductive paste marks can be easily increased or decreased. In other words, the equivalent resistances of the conductive paste marks can be adjusted according to the required resistance. In such way, the equivalent resistances of all conductive paste marks very close. Since the difference between the equivalent resistances of different conductive paste marks are not large, the problem of the conventional printing process is avoided. Moreover, since the keyboard device of the present invention is not equipped with the costly diodes, the fabricating cost of the keyboard device is reduced. Moreover, since the first contact and the second contact are separated from each other through the first insulation layer and the second insulation layer, it is not necessary to install the separation layer in the membrane switch circuit member. That is, the three-layered structure of the conventional membrane switch circuit member is replaced by the two-layered structure (i.e., the first board and the second board) of the membrane switch circuit member of the present invention. Consequently, the thickness of the keyboard device is reduced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A keyboard device, comprising:
a base plate;
at least one key structure exposed outside the keyboard and connected with the base plate; and
a membrane switch circuit member arranged between the base plate and the at least one key structure, wherein when the membrane switch circuit member is pressed by the at least one key structure, at least one key signal is correspondingly generated, wherein the membrane switch circuit member comprises:
a first board comprising a first circuit pattern and a conductive paste mark, wherein the first circuit pattern is disposed on the first board, a first contact of the first circuit pattern is formed on the first board, and the conductive paste mark is disposed on the first circuit pattern and located near the first contact; and
a second board comprising a second circuit pattern, wherein a second contact of the second circuit pattern is formed on the second board, wherein when the second contact and the first contact are contacted with each other, the at least one key signal is generated, wherein the conductive paste mark is sprayed or dispensed on the first circuit pattern so as to define an equivalent resistance.

2. The keyboard device according to claim 1, wherein the first board further comprises a first insulation layer to cover the first circuit pattern and the conductive paste mark, so that the first contact is exposed outside the first insulation layer and the first board is insulated, wherein the second board further comprises a second insulation layer to cover the second circuit board, so that the second contact is exposed outside the second insulation layer and the second board is insulated.

3. The keyboard device according to claim 2, wherein the first insulation layer and the second insulation layer are contacted with each other, and the first contact and the second contact are separated from each other through the first insulation layer and the second insulation layer.

4. The keyboard device according to claim 2, wherein the membrane switch circuit member further comprises a waterproof adhesive between the first insulation layer and the second insulation layer so as to prevent a foreign liquid from contacting with the first circuit pattern or the second circuit pattern.

5. The keyboard device according to claim 1, wherein the first circuit pattern is printed on the first board, and the second circuit pattern is printed on the second board.

6. A keyboard device, comprising:
a base plate;
at least one key structure exposed outside the keyboard and connected with the base plate; and
a membrane switch circuit member arranged between the base plate and the at least one key structure, wherein when the membrane switch circuit member is pressed by the at least one key structure, at least one key signal is correspondingly generated, wherein the membrane switch circuit member comprises:
a first board comprising a conductive paste mark and a first circuit pattern, wherein the conductive paste mark is disposed on the first circuit pattern, the first circuit pattern is disposed on the first board to cover the conductive paste mark, and a first contact of the first circuit pattern is formed on the first board; and
a second board comprising a second circuit pattern, wherein a second contact of the second circuit pattern is formed on the second board, wherein when the second contact and the first contact are contacted with each other, the at least one key signal is generated, wherein the conductive paste mark is sprayed or dispensed on the first board so as to define an equivalent resistance.

7. The keyboard device according to claim 6, wherein the first board further comprises a first insulation layer to cover the first circuit pattern and the conductive paste mark, so that the first contact is exposed outside the first insulation layer and the first board is insulated, wherein the second board further comprises a second insulation layer to cover the second circuit board, so that the second contact is exposed outside the second insulation layer and the second board is insulated.

8. The keyboard device according to claim 7, wherein the first insulation layer and the second insulation layer are contacted with each other, and the first contact and the second contact are separated from each other through the first insulation layer and the second insulation layer.

9. The keyboard device according to claim 7, wherein the membrane switch circuit member further comprises a waterproof adhesive between the first insulation layer and the second insulation layer so as to prevent a foreign liquid from contacting with the first circuit pattern or the second circuit pattern.

10. The keyboard device according to claim 6, wherein the first circuit pattern is printed on the first board, and the second circuit pattern is printed on the second board.
